(19) United States
(12) Patent Application Publication
(10) Pub. No.: US 2026/0358508 A1
(43) Pub. Date: Nov. 12, 2026

(54) Method for Detecting at least one Prolonged Interfering Influence on the GNSS Reception in the Environment of a GNSS Receiver of a Vehicle

(71) Applicant: Robert Bosch GmbH, Stuttgart (DE)

(72) Inventors: Jens Strobel, Freiberg Am Neckar (DE); Mohammad Tourian, Stuttgart (DE)

(21) Appl. No.: 19/127,858

(22) PCT Filed: Oct. 4, 2023
(86) PCT No.: PCT/EP2023/077396

§ 371 Date: May 7, 2025

(30) Foreign Application Priority Data
Nov. 10, 2022 (DE) 10 2022 211 922.3

(51) Int. Cl. G01S 19/21

(52) U.S. Cl. CPC G01S 19/21

(57) ABSTRACT

A method for detecting at least one long-lasting interference with the GNSS reception in the environment of a GNSS receiver of a vehicle is disclosed. The method includes (i) determining a first time series of data to describe the signal-to-noise ratio of at least one GNSS signal received by way of the GNSS receiver during a first observation window, (ii)
determining at least a second time series of data to describe the signal-to-noise ratio of at least one GNSS signal received by the GNSS receiver during at least one second observation window, wherein the times of the first observation window and the second observation window overlap partially, and (iii) analyzing whether a conclusion can be drawn regarding a long-lasting interference in the environment of the GNSS receiver from the time series of data to describe the signal-to-noise ratio.

The invention relates to a method for detecting at least one long-lasting interference with GNSS reception in the environment of a GNSS receiver of a vehicle that is moved in relation to the earth's surface by means of the vehicle. Moreover, a computer program, a locating system, as well as a use of a GNSS reflectometry method are described. The invention can in particular be used in GNSS-based locating systems for at least partially automated, autonomous or semi-autonomous driving.

### PRIOR ART

Using the Global Navigation Satellite System (GNSS), it is possible to make a geospatial position determination at any point on earth. A GNSS satellite orbits the earth and transmits encoded signals that the GNSS receiver uses to calculate the distance or spacing between the receiver and the satellite by estimating the time difference between the time of signal reception and the transmission time. For example, the estimated distances to satellites can be converted by GNSS sensors into an estimate of the position of the receiver if enough satellites are tracked (typically more than 5). Currently, there are more than 130 GNSS satellites orbiting the earth, meaning that at most 65 of them are usually visible on the local horizon.

In recent years, satellite-based position determination has undergone rapid development. In the beginnings of satellite navigation, GNSS receivers had to rely on a single constellation of satellites in orbit, either the American GPS or the Russian GLONASS system, in order to determine their position. Today, with the European Galileo system and the Chinese Beidou system, there are more ready-to-use systems as well as several regional extension systems added to the two original systems. Today, multi-constellation GNSS receivers, which can simultaneously receive signals from all GNSS constellations in orbit, are the norm. As a result, the receivers are able to track a larger number of satellites, even if large portions of the sky are obscured, such as in urban (or actual) street canyons, which increases accuracy and reduces the time for position determination.

Multipath effects are an important source of errors for Global Navigation Satellite Systems (GNSS) receivers. This phenomenon relates to the combination of line-of-sight (LOS) signals and a series of non-line-of-sight (NLOS) signals that are reflected from nearby obstacles one or more times before reaching the receiver antenna. Multipath signals differ from the LOS signal in power, code delay, carrier phase and frequency, which all distort the correlation curve between the received signal and the replica generated by the receiver, which can result in pseudorange errors (code phase) of tens of meters. Multipath interference occurs when a signal reaches the antenna in various ways. Its main cause is the proximity of the antenna to the reflective structures and it is important when the signal comes from a low elevation satellite. This error is different for different frequencies. It affects both the phase measurements and the code measurements. In the case of the code, it may reach a theoretical value of 1.5 times the wavelength (“chip”). This means, for example, that the multipath in the GPS-C1 code may be up to 450 meters, although upper values of more than 15 meters are difficult to observe. Typically, it is less than 2 or 3 meters. The theoretical maximum of the phase is one quarter of the wavelength. For the GPS-L1 or -L2 signals, this means about 5 centimeters, but typically it is less than 1 centimeter.

Numerous techniques have been developed to mitigate multipath effects in the literature. Among the methods for reducing multipath effects studied, techniques to monitor signal quality and integrity on the receiver level have received a lot of attention as they do not require any major hardware changes. A typical GNSS receiver consists of an HF front end that converts and scans the HF signal downwards, a signal processing stage in which the signals are sensed, tracked, and measurements are generated, and a navigation solution. Integrity monitoring may be performed at each of these levels. The multipath error can be minimized by improving the quality of the antenna, i.e. by weakening the signal coming from certain directions of low elevation and removing the antenna (if possible) from reflective objects.

### DISCLOSURE OF THE INVENTION

Here, according to claim 1, a method for detecting at least one long-lasting interference with the GNSS reception in the environment of a GNSS receiver of a vehicle, which can or will be moved by means of the vehicle in relation to the earth's surface is proposed, comprising at least the following steps:
a) determine a first time series of data to describe the signal-to-noise ratio of at least one GNSS signal received by the GNSS receiver during a first observation window,
b) determine at least a second time series of data to describe the signal-to-noise ratio of at least one GNSS signal received by the GNSS receiver during at least a second observation window, wherein the first observation window and the second observation window overlap in part (but not entirely),
c) analyze whether any inference of a long-lasting interference in the environment of the GNSS receiver can be drawn from the time series of data to describe the signal-to-noise ratio;

It is particularly preferable if the GNSS receiver is moved relative to the earth's surface by means of the vehicle at least during the first observation window and the second observation window.

For example, steps a), b), and c) can be performed at least once and/or repeatedly in the sequence indicated in order to perform the method. Furthermore, steps a), b), and c), in particular steps a) and b), can be performed at least partially in parallel or simultaneously.

The method is particularly used to detect long-lasting multipath sources in dynamic situations by analyzing GNSS signals. The method first provides an approach for identifying long-lasting multipath sources in dynamic situations, in particular through time-series analysis of reflected GNSS signals from the surrounding environment.

The invention provides a method for identifying long-lasting multipath sources in dynamic scenarios, i.e. in particular with the GNSS receiver moving, for the first time. The current multipath reception suppression algorithms are based on the residues of the GNSS signals. In the case of a long-lasting multipath source, e. g. on the roof of a car, the residual-dependent method cannot identify the situation because the abnormal residue behavior is treated as normal.

The current algorithms for containing multipath errors rely on the GNSS measurements of the individual epochs and the resulting residues. Such algorithms attempt to identify measurements with unusual behavior or larger residues to detect multipath measurements. According to this principle, the current failure limiting algorithms are unable to identify a long-lasting multipath source because a long-lasting multipath source for most satellite measurements produces distorted residues. If most measurements are distorted, the solution will also be distorted resulting in the residues being small.

A long-lasting interference is understood in particular to remain static or constant even in a dynamic situation, for example if there is a movement of the GNSS receiver in relation to the earth's surface, in particular on the earth's surface. For example, the vehicle can be a motor vehicle, e.g. an automobile. The vehicle may configured for at least partially automated or autonomous driving operation.

In particular, the long-lasting interference is a long-lasting interference causing multipath propagation of GNSS signals. Such interference may be, for example, an object in the environment of the GNSS receiver. In particular, the interference is an object that is fixedly or releasably connected to the vehicle. The object may be arranged in the area of the GNSS receiver and/or may impair a signal reception of the GNSS receiver. For example, the object may be a bicycle or roof box disposed on or on top of the vehicle.

According to an advantageous embodiment, it is proposed that the time series represent determined signal-to-noise ratio data on the elevation angle of the GNSS satellite emitting the GNSS signal. For example, the determined signal-to-noise ratio data may be the particular signal-to-noise ratio of reflected GNSS signals. These may be applied over the elevation angle to form the time series.

According to a further advantageous embodiment, it is proposed that a variation of the signal-to-noise ratio is analyzed to detect a reflected GNSS signal. In particular, it is proposed herein to use the variation of the signal-to-noise ratio (SNR) in the GNSS signal to identify long-lasting multipath sources. In other words, this can also be described such that the change in the signal-to-noise ratio, which can be observed with long-lasting multipath interference, may be used to detect the reception of reflected GNSS signals.

For example, within a time window, the long-term behavior of the signal-to-noise ratio (SNR) for each satellite may be removed. This may be done, for example, by using a 1st degree polynomial to obtain the signal-to-noise ratio of reflected GNSS signals (SNR_{reflectance}) (SNR minus long-term behavior). Subsequently, the values for SNR_{reflectance} can be analyzed along with the elevation angle of the individual satellites.

According to a further advantageous configuration, it is proposed that a spectral analysis is performed in step c). For example, the spectral analysis may be a Fourier analysis. Preferably, the spectral analysis is a Lomb-Scargle analysis. For example, the spectral analysis may be performed for the purpose of identifying a multipath reflectance height.

For example, long-lasting multipath sources may be identified in connection with the spectral analysis if the periodogram has a relatively strong performance (for example, greater than twice the median of the performance). Low reflectance height performances (for example, height less than 1 meter) may, by way of example, be evaluated as long-lasting multipath sources mounted on the vehicle. High reflectance heights may be rated as an environmentally caused, long-lasting multipath source.

According to a further advantageous embodiment, it is proposed to check whether periodic variations are present in the analyzed data when considered in the time range or if dominant frequencies are present in the analyzed data when considered in the spectral range that allow inference of a long-lasting interference in the environment of the GNSS receiver.

In particular if at least one dominant frequency is in the same range for the first time series or the first observation time window and the second time series or the second observation time window, a long-lasting interference (in the dynamic case) can be particularly advantageously inferred.

According to a further advantageous embodiment, it is proposed that an object disposed on the vehicle is identified as interference if a reflectance height determined in the context of the analysis is below a pre-definable limit. For example, a reflectance height may be determined from at least one signal-to-noise ratio of a reflected GNSS signal. In particular, a spectral analysis may be performed to determine a reflectance height. Furthermore, for example, an object disposed on the vehicle may be identified as interference if the reflectance height is below a pre-definable limit.

According to another advantageous embodiment, it is proposed that a detected long-lasting interference is considered in determining at least one integrity parameter regarding the integrity of a GNSS-based location result for locating the vehicle. For example, the integrity parameter may describe a confidence interval in which a locating result with a pre-definable minimum probability actually lies. Preferably, the integrity parameter can be what is referred to as a protection level. For example, the integrity parameter may be utilized to weight the GNSS impact on localization as needed. For example, the GNSS influence, in particular a weight of the GNSS signals, may be weighted less when a long-lasting interference has been determined. In this case, for example, the localization may be realized predominantly by means of inertia navigation or other alternative solutions.

In particular, identified long-lasting multipath sources may be used, for example, as a monitor to improve locating performance and/or improve the integrity of a GNSS-based system.

According to a further aspect, a locating system for a vehicle is proposed comprising at least one GNSS receiver disposed on the vehicle, a locating device, and a module for detecting at least long-lasting interference with the GNSS reception in the environment of the GNSS receiver, wherein the locating system is configured to perform a method described herein.

The module for detecting at least a long-lasting interference can, for example, comprise a computer and/or a control controller capable of executing commands in order to carry out the method. For this purpose, the computer or the controller can execute the computer program indicated here, for example. For example, the computer or the controller can access the described storage medium in order to be able to execute the computer program.

According to a further aspect, a computer program comprising commands that cause the locating system to perform the method described herein is proposed. In other words, the computer program relates in particular to a computer program (product) comprising commands which, when the program is executed by a computer, prompt said computer to perform a method described herein.

Furthermore, a machine-readable storage medium on which the computer program proposed here is stored or saved can also be indicated. The machine-readable storage medium is typically a computer-readable data carrier.

According to a further aspect, a use of a GNSS reflectometry method (SNR method) for detecting at least one long-lasting interference with the GNSS reception in the environment of a GNSS receiver of a vehicle is indicated, wherein the GNSS receiver is moved in relation to the earth's surface by means of the vehicle.

The details, features and advantageous embodiments discussed in connection with the method can accordingly also occur in the locating system and/or computer program and/or use presented here, and vice versa. In this respect, reference is made in full to the statements there regarding the more detailed characterization of the features.

The solution presented here and its technical environment are explained in more detail below, using the figures. It should be noted that the invention is not intended to be limited by the exemplary embodiments shown. In particular, unless explicitly stated otherwise, it is also possible to extract partial aspects of the facts explained in the figures and to combine them with other components and/or insights from other figures and/or the present description. Shown schematically are:

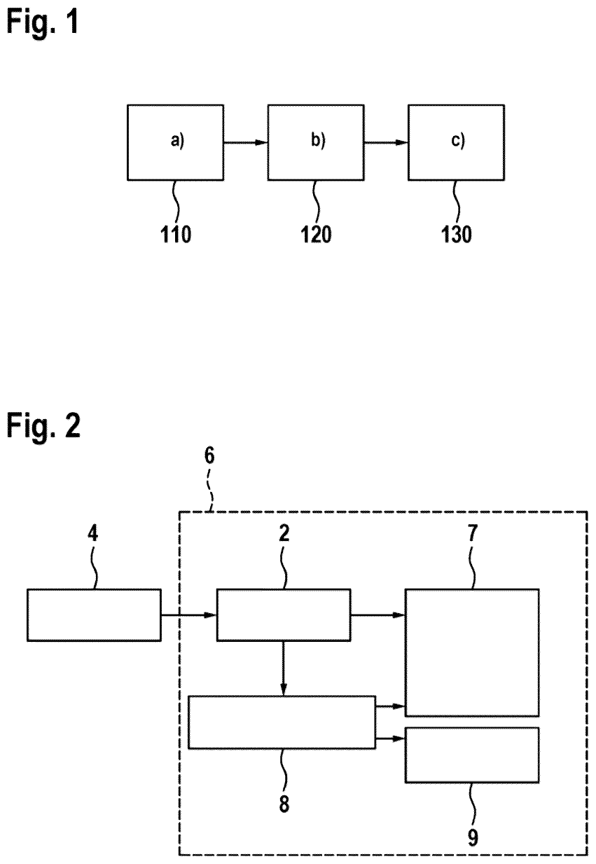

FIG. 1: an exemplary sequence of the method presented herein.

FIG. 2: An exemplary structure of the locating system presented here.

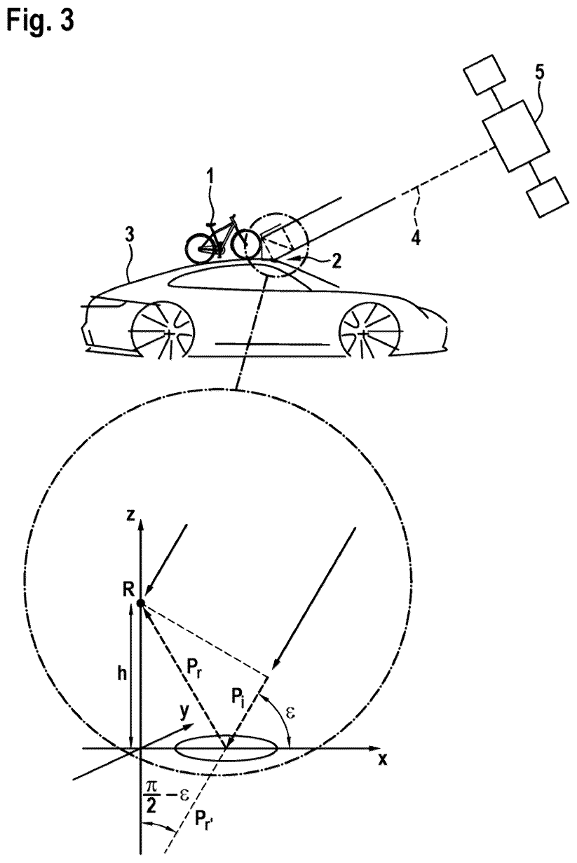

FIG. 3: an exemplary illustration of an application of the method described herein.

FIG. 1 schematically shows an exemplary sequence of the method presented herein. The method serves to detect at least one long-lasting interference 1 with the GNSS reception in the environment of a GNSS receiver 2 of a vehicle 3, which is moved in relation to the earth's surface by means of the vehicle 3. The sequence of steps a), b) and c) shown with blocks 110, 120 and 130 is an example and can, for example, be carried out at least once in the shown sequence to carry out the method.

In block 110, according to step a), a first time series of data to describe the signal-to-noise ratio of at least one GNSS signal 4 received by means of the GNSS receiver 2 during a first observation window is determined. In block 120, according to step b), at least a second time series of data to describe the signal-to-noise ratio of at least one GNSS signal 4 received by means of the GNSS receiver 2 during at least one second observation window is determined, wherein the times of the first observation window and the second observation window overlap partially. In block 130, according to step c), an analysis is conducted to determine whether a long-lasting interference 1 in the environment of the GNSS receiver 2 can be inferred from the time series of data to describe the signal-to-noise ratio.

The method is in particular characterized in that the GNSS receiver 2 is moved in relation to the earth's surface at least during the first observation window and the second observation window by means of the vehicle 3.

FIG. 2 schematically shows an exemplary structure of the locating system 6 presented here for a vehicle 3. The locating system 6 comprises at least one GNSS receiver 2 disposed on the vehicle 3, a locating device 7, and a module 8 for detecting at least one long-lasting interference 1 with the GNSS reception in the environment of the GNSS receiver 2, wherein the locating system 6 is configured to perform a method according to any of the preceding claims. Moreover, FIG. 2 also shows a module 9 for determining integrity information, such as a protection level, using the results of the locating device 7. The locating device 7 may comprise a locating filter.

FIG. 3 schematically shows an exemplary illustration of an application of the method described herein. The interference 1 here, by way of example, is a bicycle mounted on a vehicle 3 and causing reflections and thus multipath signal propagation of GNSS signals 4 in the direct environment of the GNSS receiver 2. Even in dynamic driving situations, i.e. driving along the earth's surface and thus variable reception situations, the bicycle represents a long-lasting or constant interference. The method advantageously helps to ensure that the interference 1 thus existing can advantageously be detected easily and reliably.

The time series may represent determined signal-to-noise ratio data at the elevation angle s of the GNSS satellite 5 emitting the GNSS signal 4. In particular, during both the first observation window and the second observation window, at least one time series of signal-to-noise ratio data may be determined at the elevation angle s for which the data is determined and stored as, for example, pairs of values.

A variation of the signal-to-noise ratio can in particular be analyzed based on the data determined in this way in order to detect a reflected GNSS signal 4. For example, a spectral analysis may be performed to do so. The spectral analysis may preferably be a Lomb-Scargle analysis.

For example, to analyze the variation in the signal-to-noise ratio, a check can be carried out to determine whether periodic variations are present in the analyzed data when considered in the time range or if dominant frequencies are present when considered in the spectral range that allow an inference of a long-lasting interference 1 in the environment of the GNSS receiver 2.

In the dynamic case, i.e. with the moving GNSS receiver 2, no periodic variations would usually be expected with undisturbed signal reception. Rather, if periodic structures are present in the dynamic case, an inference of a constant interference is possible.

Each time series may be subjected to a spectral analysis. By means of the spectral analysis, the periodic signal structures can be particularly advantageously detected or identified or worked out. For example, dominant frequencies (e.g. f=2 Hr/lambda; wherein Hr stands for reflectance height here) may be detected in the spectral range. Where dominant frequencies are present, they may permit inference of multipath sources.

In particular if at least one dominant frequency is in the same range for the first time series or the first observation time window and the second time series or the second observation time window, a long-lasting interference (in the dynamic case) can be particularly advantageously inferred. In other words, this can be described in particular such that if a match/consistency in dominant frequencies can be observed in examination windows/time series at different times (at least partially overlapping), a long-lasting interference can be inferred in the dynamic case.

The mathematical relationships are explained below, by way of example, on the basis of the illustration according to FIG. 3. Here, x,y,z denote an exemplary coordinate system, Pᵣ, P_{r′}, and Pᵢ, respectively denote spatial distances, s denotes the elevation angle, h the reflectance height, and R an exemplary reflectance point.

According to the sketch in FIG. 3, the excess path of a reflected GNSS signal δ=P_i+P_r can be calculated as follows:

$$δ = 2 h cos ( \frac{π}{2} - ε ) = 2 h sin ε$$

Here, ε is the elevation angle of a satellite and h is the reflectance height. According to such a relationship, the reflectance height can be obtained by knowing the excess path as follows:

$$h = \frac{δ}{2 sin ε}$$

The above formulation is a geometric perspective. Taking into account the waveform of the direct and the reflected signal, the following two equations for the signal-to-noise ratio of the direct signal may be established:

SNR_{dir}=V cos(φ)

Wherein V is the amplitude and φ the phase of the received SNR. Since the amplitude of the reflected signal is attenuated, a damping factor β may be considered. Since the reflected signal comes with a time delay, a phase shift ΔΦ can be considered in the representation of the reflected SNR (SNR_{ref}):

SNR_{ref}=βV cos(φ+Δφ)

ΔΦ is a function of the excess path, and as we have seen before, it's also a function of the elevation angle. Therefore, we can state:

$$Δφ = \frac{2 π}{λ} δ = \frac{2 π}{λ} 2 h sin ε = \frac{4 π h}{λ} sin ε$$

If we use the formula above and write PV as A for the amplitude of the reflected SNR, we can state:

$${SNR}_{ref} = A cos ( \frac{4 π h}{λ} sin ε + φ )$$

The equation described allows the reflectance height h to be obtained in an advantageous manner by a spectral analysis of the SNR_Ref. In particular, the SNR_Ref may first be determined for each satellite. For this purpose, the long-term behavior of the SNR of a GNSS signal as a function of the elevation angle of the relevant satellite may first be removed. After removing the long-term behavior and obtaining the SNR_Ref, a Lomb-Scargle analysis may be performed to obtain the power spectral density for different height reflectances. Height reflectance with a dominant power spectrum may be determined as the height of a reflectance point R.

The method described is an advantageous approach to GNSS reflectometry. Here, such an approach is used for the first time application in a dynamic situation, particularly while driving a vehicle 3. In particular, it is proposed for the first time to use a GNSS reflectometry approach in a driving scenario to detect a long-lasting multipath source. For example, a long-lasting multipath source in a driving scenario may be present if the driver attaches an object (bicycle, suitcase) to the roof of the car.

Thus, an example is described showing that and, if necessary, how an object disposed on the vehicle 3 (here, a bicycle) can be identified as an interference 1. This may be advantageously identified, for example, if a reflectance height h determined in the context of the analysis is below a pre-definable limit.

In another advantageous embodiment, a detected long-lasting interference 1 may be considered when determining at least one integrity parameter regarding the integrity of a GNSS-based locating result for locating the vehicle 3. For example, the integrity parameter may be a protection level.

For example, in the context of the invention, a GNSS reflectometry (SNR) method may be used to detect at least one long-lasting interference 1 with the GNSS reception in the environment of a GNSS receiver 2 of a vehicle 3, wherein the GNSS receiver 2 is moved relative to the earth surface by means of the vehicle 3.

1. A method for detecting at least one long-lasting interference with GNSS reception in the environment of a GNSS receiver of a vehicle, comprising:
a) determining a first time series of data to describe the signal-to-noise ratio of at least one GNSS signal received by way of the GNSS receiver during a first observation window,
b) determining at least a second time series of data to describe the signal-to-noise ratio of at least one GNSS signal received by way of the GNSS receiver during at least one second observation window, wherein the times of the first observation window and the second observation window overlap partially, and
c) analyzing whether a conclusion can be drawn regarding a long-lasting interference in the environment of the GNSS receiver from the time series of data to describe the signal-to-noise ratio.

2. The method according to claim 1, wherein the GNSS receiver is moved relative to the earth's surface at least during the first observation window and the second observation window by way of the vehicle.

3. The method according to claim 1, wherein the time series represent determined signal-to-noise ratio data regarding the elevation angle of the GNSS satellite emitting the GNSS signal.

4. The method according to claim 1, wherein a variation of the signal-to-noise ratio is analyzed to detect a reflected GNSS signal.

5. The method according to claim 1, wherein a spectral analysis is carried out in step c).

6. The method according to claim 1, wherein a check is conducted to determine whether periodic variations are present in the analyzed data when considered in the time range or whether dominant frequencies are present in the analyzed data when considered in the spectral range that allow a conclusion to be drawn regarding a long-lasting interference in the environment of the GNSS receiver.

7. The method according to claim 1, wherein an object disposed on the vehicle is identified as an interference when a reflectance height determined in the context of the analysis is below a pre-definable limit.

8. The method according to claim 1, wherein a detected long-lasting interference is considered when determining at least one integrity parameter regarding the integrity of a GNSS-based locating result for locating the vehicle.

9. A locating system for a vehicle comprising at least one GNSS receiver disposed on the vehicle, a locating device, and a module configured to detect at least one long-lasting interference with the GNSS reception in the environment of the GNSS receiver, wherein the locating system is configured to perform a method according to claim 1.

10. A computer program comprising commands that cause a locating system to perform the method steps according to claim 1, wherein:
the locating system comprises at least one GNSS receiver disposed on the vehicle, a locating device, and a module configured to detect at least one long-lasting interference with the GNSS reception in the environment of the GNSS receiver.

11. Use of a GNSS reflectometry method for detecting at least one long-lasting interference with the GNSS reception in the environment of a GNSS receiver of a vehicle, wherein the GNSS receiver is moved relative to the earth's surface by way of the vehicle.
